(19) United States
(12) Patent Application Publication
(10) Pub. No.: US 2009/0151629 A1
(43) Pub. Date: Jun. 18, 2009

(54) PAINT-SUPPLYING DEVICE AND PAINT-SPRAYING SYSTEM USING SAME

(75) Inventors: LI-HUA ZHANG, Shenzhen (CN); JIAN-CHUN YANG, Shenzhen (CN); JUN-ZHEN FENG, Shenzhen (CN); LI-PING SUN, Shenzhen (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/967,029

(22) Filed: Dec. 29, 2007

(30) Foreign Application Priority Data
Dec. 14, 2007 (CN) 200710203080.0

(51) Int. Cl. B05B 7/00

(52) U.S. Cl. 118/313

(57) ABSTRACT

A paint-supplying device (14) for supplying paint to a paint chamber (11) is provided. The paint-supplying device includes an accommodating cavity (143) and a plurality of paint barrels (145). The accommodating cavity is integrally defined with the paint chamber. The accommodating cavity communicates with the paint chamber. The plurality of paint barrels is accommodated in the accommodating cavity and configured for supplying paint to the paint chamber. A paint-spraying system (10) using the present paint-supplying device is further provided.

### BACKGROUND OF THE INVENTION

1. Field of the Invention

The present invention relates to paint-supplying devices, particularly to a paint supplying device used in a paint-spraying system.

2. Description of Related Art

Usually, a decorative shell of a portable electronic device (e.g., a mobile phone) is paint-sprayed by a paint-spraying system. The paint-spraying system typically includes an external paint-supplying device and a paint chamber. The paint-supplying device supplies paint to the paint chamber.

The paint chamber has a gas-releasing device mounted therewith. Also, the paint-supplying device is particularly equipped with an external gas-releasing device. The two gas-releasing devices function to release/expel dust and/or painting fog from the paint-supplying device and the paint chamber.

However, the additional equipped gas-releasing device with the paint-supplying device increase energy-consuming and maintenance expenses and, thus is costly.

Therefore, a heretofore-unaddressed need exists in the art to address the aforementioned deficiencies and inadequacies.

### SUMMARY

In present aspect, a paint-supplying device for supplying paint to a paint chamber is provided. The paint-supplying device includes an accommodating cavity and a plurality of paint barrels. The accommodating cavity is integrally defined with the paint chamber. The accommodating cavity communicates with the paint chamber. The plurality of paint barrels is accommodated in the accommodating cavity and configured for supplying paint to the paint chamber.

In another aspect, a paint-spraying system using the present paint-supplying device is provided. The paint-spraying system further includes a paint chamber and a gas-releasing device. The gas-releasing device is configured for releasing dust and/or painting fog from the paint chamber.

These and other aspects of the present invention will become more apparent from the following detailed description of the preferred embodiments taken in conjunction with the accompanying drawings, although variations and modifications therein may be affected without departing from the spirit and scope of the novel concepts of the disclosure.

### BRIEF DESCRIPTION OF THE DRAWINGS

Many aspects of the present paint-supplying device and paint-spraying system using same can be better understood with reference to the following drawings. These drawings are not necessarily drawn to scale, the emphasis instead being placed upon clearly illustrating the principles of the present paint-supplying device and the paint-spraying system using same. Moreover, in the drawings like reference numerals designate corresponding parts throughout the several views. Wherever possible, the same reference numbers are used throughout the drawings to refer to the same or like elements of an embodiment.

FIG. 1 is an isometric view of a paint-spraying system in accordance with a present embodiment.

FIG. 2 is an isometric view of the paint-spraying system shown in FIG. 1, the paint-spraying system being provided without a first sidewall thereof.

FIG. 3 is an exploded and isometric view of a paint-supplying device of the paint-spraying system shown in FIG. 1.

FIG. 4 is another exploded and isometric view of the paint-supplying device of the paint-spraying system shown in FIG. 1, showing another aspect thereof.

FIG. 5 is an assembled view of the paint-supplying device shown in FIG. 3.

### DETAILED DESCRIPTION OF THE EMBODIMENTS

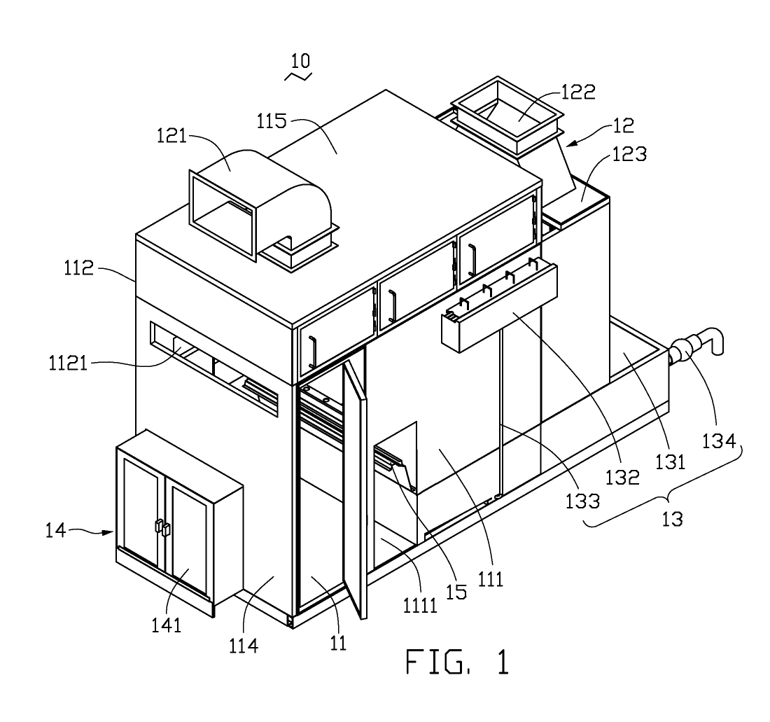

The present paint-supplying device and the paint-spraying system using the paint-supplying device are described here in conjunction with the accompanying drawings in FIGS. 1 through 5. The paint-spraying system is used for paint-spraying articles, such as shell of an electronic device (e.g., a mobile phone).

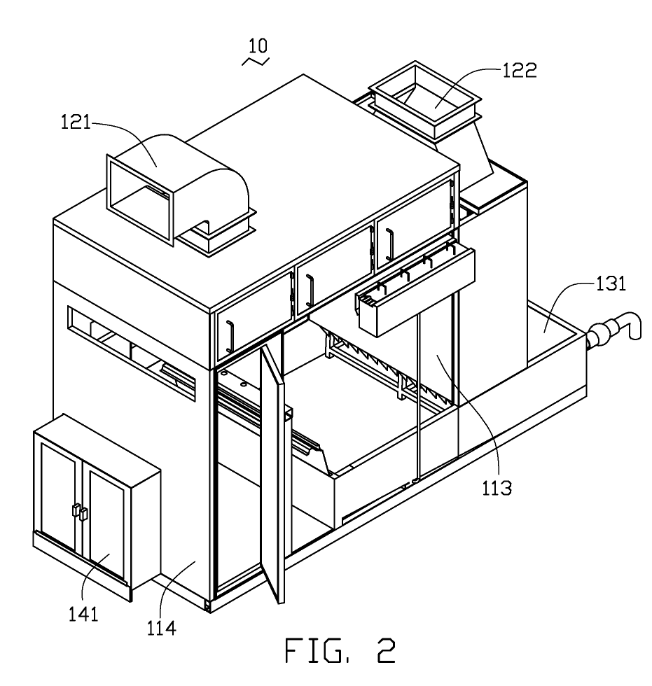

Referring to FIG. 1 and FIG. 2, the paint-spraying system 10 includes a paint chamber 11, a gas-releasing device 12, a water-cycling device 13, a paint-supplying device 14, and a production line 15. The paint-supplying device 14, the gas-releasing device 12, and the water-cycling device 13 are respectively formed on corresponding side of the paint chamber 11. The production line 15, which is configured (i.e., structured/arranged) for carrying the articles, is disposed into the paint chamber 11 and positioned within the paint chamber 11.

The paint chamber 11 is advantageously made by welding a plurality of coated steel boards together. The paint chamber 11 includes a first sidewall 111, a second sidewall 112, a third sidewall 113, a fourth sidewall 114, and an upper wall 115. The first sidewall 111 and the second sidewall 112 are disposed opposite to each other. The third sidewall 113 has two ends respectively connecting with the first sidewall 111 and the second sidewall 112. The first sidewall 111 and the second sidewall 112 define a first opening 1111 and a second opening 1121 therethrough, respectively. The first opening 1111 and the second opening 1121 are configured for cooperatively facilitating the production line 15 passing therethrough and thus being located in the paint chamber 11.

The gas-releasing device 12 is configured for releasing dust and/or painting fog from the paint chamber 11. The gas-releasing device 12 includes a conventional windmill pump (not illustrated), a gas inlet 121, a gas outlet 122, and a base chamber 123. The gas inlet 121, the paint chamber 11, the base chamber 123, and the gas outlet 122 sequentially communicate with each other in the written order. The windmill pump is disposed on the upper wall 115 of the paint chamber 11. The windmill pump is configured for sucking clean air from the gas inlet 121 into the paint chamber 11 and, also configured for expelling/releasing dust and/or painting fog mixed with the clean air through the base chamber 123 and the gas outlet 122 from the paint chamber 11.

The water-cycling device 13 includes a water channel 131, a water pump 132, an inlet pipe 133, and an outlet pipe 134. The water channel 131 is disposed at the bottom of the paint-spraying system 10 and has an opening (not labeled) defined therein. The water channel 131 is partially located in the paint chamber 11 and the base chamber 123 with the opening communicating with the paint chamber 11 and the base chamber 123. As such, the water channel 131 is partially exposed from the paint chamber 11 and the base chamber 123. The outlet pipe 134 communicates with the water channel 131 and is configured for releasing water from the water channel 131.

The water pump 132 is secured on the first sidewall 111 of the paint chamber 11. The water pump 132 communicates with the water channel 131 via the inlet pipe 133. As such, the water pump 132 can suck clean water from the water channel 131 to the respective top of the first sidewall 111, the second sidewall 112, and the third sidewall 113 of the paint chamber 11 via the inlet pipe 133. During sucking water process, the clean water flows along interior surfaces of the first sidewall 111, the second sidewall 112, and the third sidewall 113 and, thus forming three respective water screens (not illustrated). The water screens can further eliminate dust and/or painting fog of the paint chamber 11.

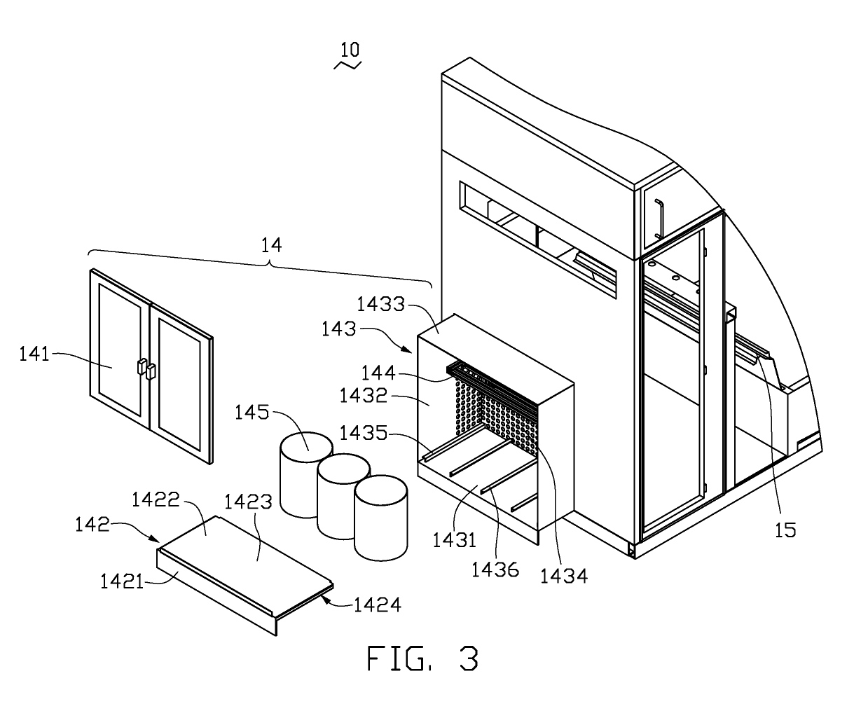

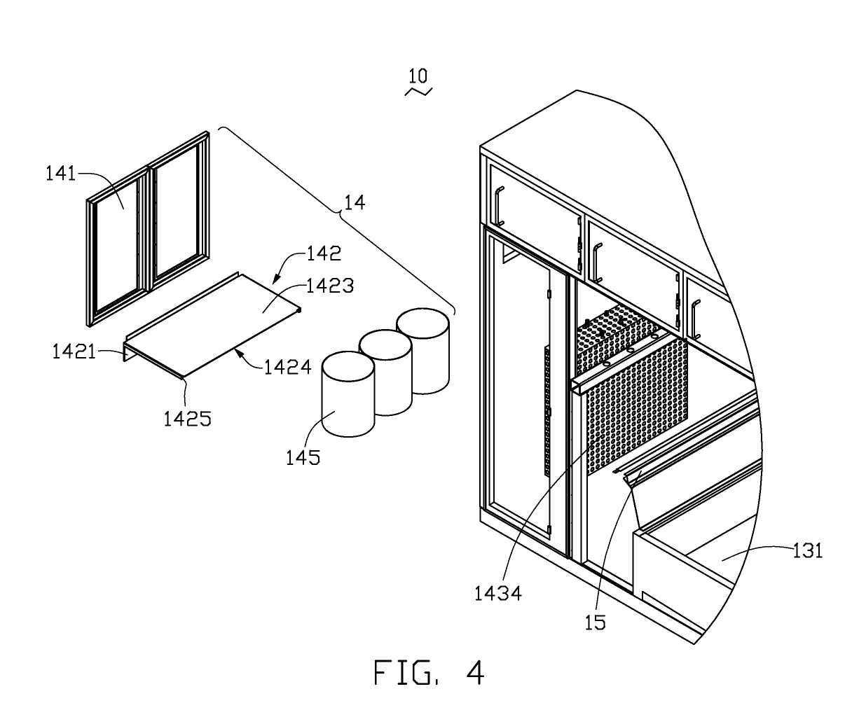

Referring further to FIG. 3 and FIG. 4, the paint-supplying device 14 includes a door 141, a sliding board 142, an accommodating cavity 143, a conventional bracket 144, and a plurality of paint barrels 145. The door 141 is generally rectangular and rotatably mounted to close an opening of the accommodating cavity 143. The sliding board 142 is generally L-shaped board and includes a general rectangular resisting portion 1421 and a general rectangular supporting portion 1422. The resisting portion 1421 connects with the supporting portion 1422. The supporting portion 1422 is configured for supporting the plurality of paint barrels 145. The supporting portion 1422 includes an upper wall 1423, a lower wall 1424, and two guiding grooves 1425. The two guiding grooves 1425 are defined by bending two opposite ends of the upper wall 1423 towards the lower wall 1424.

The accommodating cavity 143 is integrally formed with the paint chamber 11. The accommodating cavity 143 is generally rectangular and enclosed by a lower board 1431, two side boards 1432, an upper board 1433, and a partitional board 1434. The lower board 1431, the two side boards 1432, and the upper board 1433 are respectively formed on the second sidewall 112 of the paint chamber 11. The partitional board 1434 is located within the paint chamber 11 and has a plurality of cellular holes (not labeled) defined therethrough. Thus, the accommodating cavity 143 communicates with the paint chamber 11 via the plurality of cellular holes.

The lower board 1431 has two guiding rails 1435 corresponding with the two guiding grooves 1425 formed thereon. The lower board 1431 further has a plurality of rib rods 1436 formed thereon. The plurality of rib rods 1436 is configured for supporting the sliding board 142 as the sliding board 142 slides into the accommodating cavity 143 and carries the plurality of paint barrels 145.

The bracket 144 is attached (e.g., welded) with the two side boards 1432 of the accommodating cavity 143. The bracket 144 is configured for securing a plurality of conventional oil pumps (not illustrated) therewith. The plurality of oil pumps corresponds with the plurality of paint barrels 145. Each of the plurality of paint barrels 145 has paint accommodated therein. Each oil pump has one end thereof immerged into the paint barrel's paint of the corresponding paint barrels 145, and has the other end connected with a conventional spraying gun (not illustrated).

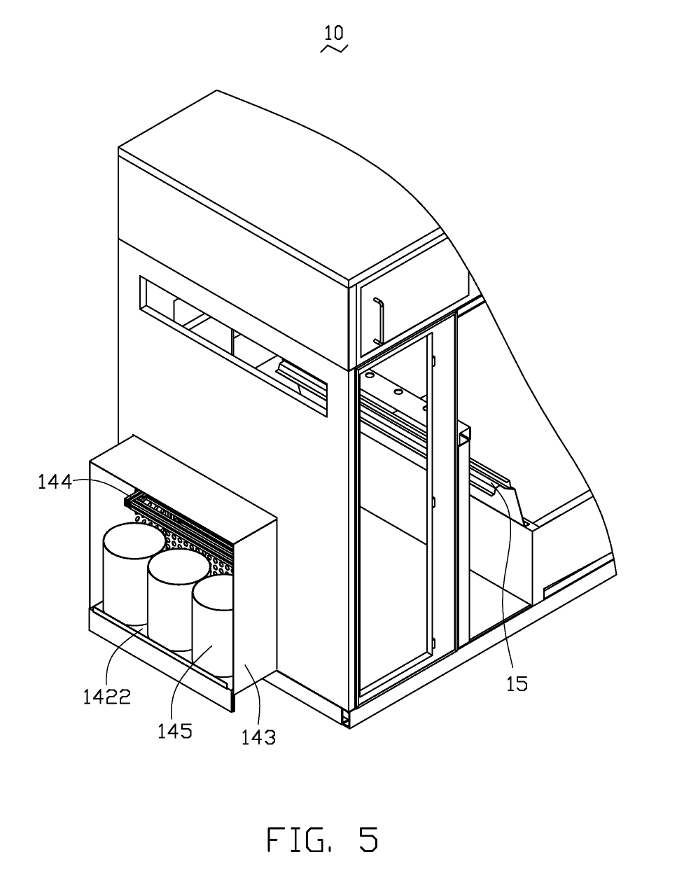

During assembly of the paint-supplying device 14, referring to FIG. 5, the two guiding rails 1435 of the accommodating cavity 143 are respectively aligned with the two guiding grooves 1425 of the sliding board 142. As the resisting portion 1421 of the sliding board 142 being pushed towards the accommodating cavity 143, the sliding board 142 slides into the accommodating cavity 143 via sliding of the guiding rails 1435 relative to the guiding grooves 1425. The plurality of paint barrels 145 are placed on the supporting portion 1422 of the sliding board 142 and respectively have the plurality of oil pumps connecting therewith. The door 141 is mounted to close the accommodating cavity 143.

In use, the production line 15 transfers the articles into the paint chamber 11. Each oil pump transfers the paint from each paint barrel to each spraying gun. Each spraying gun sprays the paint on the articles. During this stage, the gas-releasing device 12 and the water-cycling device 13 respectively expel/release dust and/or painting fog from the paint chamber 11 and the paint-supplying device 14.

One main advantage of the present embodiment embodies that, due to the paint-supplying device 14 is integrally formed and communicates with the paint chamber 11 paint chamber, the dust and/or painting fog of the paint-supplying device 14 is released by the gas-releasing device 12 and the water-cycling device 13. No additional gas-releasing device 12 is required for releasing dust and/or painting fog of the paint-supplying device 14. Thus, cost of the paint-spraying system 10 is decreased.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A paint-supplying device for supplying paint to a paint chamber, comprising:
an accommodating cavity integrally defined with the paint chamber, the accommodating cavity communicating with the paint chamber; and
a plurality of paint barrels accommodated in the accommodating cavity, the plurality of paint barrels being configured for supplying paint to the paint chamber.

2. The paint-supplying device as claimed in claim 1, further comprising a lower board, two side boards, an upper board, and a partitional board, the accommodating cavity being enclosed by the lower board, the two side boards, the upper board, and the partitional board.

3. The paint-supplying device as claimed in claim 2, wherein the partitional board is located within the paint chamber and has a plurality of cellular holes defined therethrough, the plurality of cellular holes being configured for facilitating communication between the accommodating cavity and the paint chamber.

4. The paint-supplying device as claimed in claim 1, further comprising a sliding board, the sliding board comprising a resisting portion and a supporting portion, the resisting portion connecting with the supporting portion, and the supporting portion being configured for supporting the plurality of paint barrels.

5. The paint-supplying device as claimed in claim 4, wherein the supporting portion defines two guiding grooves, the accommodating cavity having two guiding rails formed therein, and the two guiding rails respectively corresponding with the two guiding grooves.

6. The paint-supplying device as claimed in claim 5, wherein the accommodating cavity have a plurality of rib rods formed therein, the plurality of rib rods being configured for supporting the sliding board.

7. The paint-supplying device as claimed in claim 1, further comprising a door, the door being configured to be rotatably mounted to close an opening of the accommodating cavity.

8. A paint-spraying system, comprising:
a paint chamber;
a gas-releasing device configured for releasing dust and/or painting fog from the paint chamber;
a paint-supplying device configured for supplying paint to a paint chamber, the paint-supplying device comprising:
an accommodating cavity integrally defined with the paint chamber, the accommodating cavity communicating with the paint chamber; and
a plurality of paint barrels accommodated in the accommodating cavity, the plurality of paint barrels being configured for supplying paint to the paint chamber.

9. The paint-spraying system as claimed in claim 8, wherein the gas-releasing device comprises a gas inlet, a gas outlet, and a base chamber, the gas inlet, the paint chamber, the base chamber, and the gas outlet sequentially communicating with each other in the written order.

10. The paint-spraying system as claimed in claim 9, further comprising a water channel, a water pump, an inlet pipe, and an outlet pipe, the water pump communicating with the water channel via the inlet pipe, and the outlet pipe communicating with the water channel.

11. The paint-spraying system as claimed in claim 10, wherein the water channel is partially located in the paint chamber and the base chamber and communicates with the paint chamber and the base chamber.

12. The paint-spraying system as claimed in claim 1, wherein the water channel has a channel portion.

13. The paint-spraying system as claimed in claim 8, further comprising a production line, the paint chamber includes two sidewalls, the two sidewalls defining two openings, and the two openings being configured for facilitating the production line passing therethrough and thus being located in the paint chamber.
